(19) United States
(12) Patent Application Publication
(10) Pub. No.: US 2025/0154391 A1
(43) Pub. Date: May 15, 2025

(54) COLD BONDING ADHESIVES FOR BONDING VULCANIZED RUBBER COMPOUNDS FOR INDUSTRIAL APPLICATIONS

(71) Applicant: Lord Corporation, Cary, NC (US)

(72) Inventors: Tarek Agag, Erie, PA (US); Jeffrey M. Matts, Erie, PA (US); Kimberly Ray Hultman, GIRARD, PA (US)

(21) Appl. No.: 18/836,450

(22) PCT Filed: Feb. 15, 2023
(86) PCT No.: PCT/US2023/013145

§ 371 Date: Aug. 7, 2024

Related U.S. Application Data
(60) Provisional application No. 63/310,429, filed on Feb. 15, 2022.

(51) Int. Cl. C09J 115/02; C09J 5/02; C09J 11/04; C09J 11/06; C09J 111/00

(52) U.S. Cl. CPC C09J 115/02; C09J 5/02; C09J 11/04; C09J 11/06; C09J 111/00; C09J 2400/166; C09J 2421/008

(57) ABSTRACT

One-part (1K) and two-part (2K) cold bonding adhesive compositions for bonding vulcanized rubber compounds are described. The compositions can be used to bond vulcanized elastomers, such as chloroprene and buffed natural rubber, to themselves or to metal. The compositions can be free of hazardous chemicals often used in cold bonding adhesives, such as monomeric isocyanates and/or trichloroethylene or other chlorinated solvents. The adhesives also offer easy application and long pot life.

### CROSS-REFERENCE TO RELATED APPLICATION

This application claims priority to U.S. Provisional Patent Application Ser. No. 63/310,429, filed Feb. 15, 2022, incorporated by reference herein in its entirety.

### TECHNICAL FIELD

The presently disclosed subject matter relates to cold bonding adhesive compositions for bonding vulcanized elastomers to themselves or to a variety of metal substrates. The compositions can be one component (1K) or two component (2K) adhesives and can be free of monomeric isocyanates and/or other harmful chemicals. The presently disclosed subject matter also relates to methods of bonding vulcanized elastomers to other substrates and to related bonded assemblies.

### BACKGROUND

Cold bonding (CB) adhesives for bonding vulcanized elastomers to themselves or to metal substrates are highly demanded technology. CB adhesives do not require mold cavities or autoclaves and can be used to perform remote site repairs of assets in service. Therefore, these room temperature curing adhesives are advantageous for post vulcanization applications typically used in mining, rubber lining, rubber roofing, flooring, shock and abrasion resistance, automotive and tire industries.

Most commercial CB systems utilize monomeric isocyanates since they provide rapid strength development. However, because of their high reactivity and volatility, monomeric isocyanates create numerous human health hazards. Trichloroethylene (TCE) is also used as a preferred carrier solvent in many commercial CB systems, since it swells rubber compounds, allowing the adhesive to easily diffuse and become entangled in the rubber compound once it cures. However, while TCE produces strong adhesion, it is now banned in many parts of the world because of its carcinogenic effects. CB adhesives also tend to quickly lose their tackiness, requiring regular reactivation with additional solvents, e.g., for lining large assets. Moreover, the majority of applications that use CB adhesives offer little ventilation and workers typically do not wear respirators, which creates a significant health hazard.

Accordingly, there is an ongoing need for new CB adhesive, particularly those that are free of chemicals with adverse health effects (e.g., carcinogenic effects) and that can still provide good adhesion. There is also a need for CB adhesives that can be readily re-tacked.

### SUMMARY

This summary lists several embodiments of the presently disclosed subject matter, and in many cases lists variations and permutations of these embodiments. This summary is merely an example of the numerous and varied embodiments. Mention of one or more representative features of a given embodiment is likewise for purposes of example. Such an embodiment can typically exist with or without the feature(s) mentioned; likewise, those features can be applied to other embodiments of the presently disclosed subject matter, whether listed in this summary or not. To avoid excessive repetition, this summary does not list or suggest all possible combinations of such features.

In some embodiments, the presently disclosed subject matter provides a one-component (1K) cold bonding adhesive composition wherein the 1K cold bonding adhesive composition comprises a chlorinated base polymer selected from a chlorinated elastomer and a chlorinated natural or synthetic rubber; a rubber curative agent selected from zinc oxide, magnesium oxide, or a mixture thereof; and an adhesion promoter; and wherein the 1K cold bonding adhesive is free of monomeric isocyanates and trichloroethylene.

In some embodiments, the 1K cold bonding adhesive, based on a total dry weight of the adhesive, comprises: (a) about 60 weight % (wt %) to about 80 wt % of the chlorinated base polymer; (b) about 10 wt % to about 20 wt % of one or more additional chlorinated base polymer; (c) about 0.5 wt % to about 3 wt % of a colorant; (d) about 4 wt % to about 10 wt % of a rheology modifier; (e) about 3 wt % to about 6 wt % of the rubber curative agent; (f) about 3 wt % to about 6 wt % of vinyltrimethoxysilane or PTSI; (g) about 3 wt % to about 6 wt % of a zeolite powder or an organonanoclay; and (h) about 2 wt % to about 6 wt % of the adhesion promoter.

In some embodiments, the presently disclosed subject matter provides a two-component (2K) cold bonding adhesive wherein the 2K cold bonding adhesive comprises a first component comprising a chlorinated base polymer, a rubber curative agent, and an adhesion promoter, and wherein the 2K cold bonding adhesive is free of trichloroethylene. In some embodiments, the first component comprises an aqueous solvent. In some embodiments, a second component of the 2K cold bonding adhesive comprises a water-dispersible polyisocyanate.

In some embodiments, the presently disclosed subject matter provides a method of bonding a vulcanized elastomer substrate to a second substrate, wherein the second substrate comprises a second vulcanized elastomer substrate or a metal substrate, wherein the method comprises: (i) applying a cold bonding adhesive of the presently disclosed subject matter to a surface of one or both of the vulcanized elastomer substrate and the second substrate, thereby providing at least one adhesive-coated surface; (ii) contacting the vulcanized rubber substrate to the second substrate wherein the at least one adhesive-coated surface is present between the vulcanized elastomer substrate and the second substrate; and (iii) curing the adhesive.

Accordingly, it is an object of the presently disclosed subject matter to provide cold bonding adhesives that are free of monomeric isocyanates and/or chlorinated solvents, as well as methods of bonding substrates using the same. These and other objects are achieved in whole or in part by the presently disclosed subject matter. Other objects and advantages of the presently disclosed subject matter will become apparent to those skilled in the art after a study of the following description, examples, and drawings.

### BRIEF DESCRIPTION OF THE DRAWINGS

The presently disclosed subject matter can be better understood by referring to the following, example figure. The components in the figure are not necessarily to scale, emphasis instead being placed upon illustrating the principles of the presently disclosed subject matter (often schematically). In the figure, like reference numerals designate corresponding parts throughout the different views. A further understanding of the presently disclosed subject matter can be obtained by reference to an embodiment set forth in the illustrations of the accompanying drawing. Although the illustrated embodiment is merely for purposes of example of systems for carrying out the presently disclosed subject matter, both the organization and method of operation of the presently disclosed subject matter, in general, together with further objectives and advantages thereof, may be more easily understood by reference to the drawings and the following description. The drawing is not intended to limit the scope of this presently disclosed subject matter, which is set forth with particularity in the claims as appended or as subsequently amended, but merely to clarify and provide examples of the presently disclosed subject matter.

FIGS. 1A-1E are a series of photographic images showing a seam bonding process for use in assessing the performance of the presently disclosed cold bonding adhesives. FIG. 1A shows a rubber sheet for use in a seam bonding process. FIG. 1B shows an edge of the rubber sheet of FIG. 1A after cleaning and prior to application of an adhesive of the presently disclosed subject matter. FIG. 1C shows an edge of the rubber sheet after application of adhesive. FIG. 1D shows the edges of the rubber sheet being brought into contact for forming a seam. FIG. 1E shows the seam bonded part formed from the rubber sheet.

### DETAILED DESCRIPTION

The presently disclosed subject matter now will be described more fully hereinafter, in which some, but not all embodiments of the presently disclosed subject matter are described. Indeed, the presently disclosed subject matter can be embodied in many different forms and should not be construed as limited to the embodiments set forth herein; rather, these embodiments are provided so that this disclosure will satisfy applicable legal requirements.

### I. Definitions

The terminology used herein is for the purpose of describing particular embodiments only and is not intended to be limiting of the presently disclosed subject matter.

While the following terms are believed to be well understood by one of ordinary skill in the art, the following definitions are set forth to facilitate explanation of the presently disclosed subject matter.

All technical and scientific terms used herein, unless otherwise defined below, are intended to have the same meaning as commonly understood by one of ordinary skill in the art. References to techniques employed herein are intended to refer to the techniques as commonly understood in the art, including variations on those techniques or substitutions of equivalent techniques that would be apparent to one of skill in the art. While the following terms are believed to be well understood by one of ordinary skill in the art, the following definitions are set forth to facilitate explanation of the presently disclosed subject matter.

In describing the presently disclosed subject matter, it will be understood that a number of techniques and steps are disclosed. Each of these has individual benefit and each can also be used in conjunction with one or more, or in some cases all, of the other disclosed techniques.

Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

Following long-standing patent law convention, the terms “a”, “an”, and “the” refer to “one or more” when used in this application, including the claims. Thus, for example, reference to “a cell” includes a plurality of such cells, and so forth.

Unless otherwise indicated, all numbers expressing quantities of ingredients, reaction conditions, and so forth used in the specification and claims are to be understood as being modified in all instances by the term “about”. Accordingly, unless indicated to the contrary, the numerical parameters set forth in this specification and attached claims are approximations that can vary depending upon the desired properties sought to be obtained by the presently disclosed subject matter.

As used herein, the term “about,” when referring to a value or to an amount of a composition, dose, sequence identity (e.g., when comparing two or more nucleotide or amino acid sequences), mass, weight, temperature, time, volume, concentration, percentage, etc., is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

The term “comprising”, which is synonymous with “including” “containing” or “characterized by” is inclusive or open-ended and does not exclude additional, unrecited elements or method steps. “Comprising” is a term of art used in claim language which means that the named elements are essential, but other elements can be added and still form a construct within the scope of the claim.

As used herein, the phrase “consisting of” excludes any element, step, or ingredient not specified in the claim. When the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of a claim to the specified materials or steps, plus those that do not materially affect the basic and novel characteristic(s) of the claimed subject matter.

With respect to the terms “comprising”, “consisting of”, and “consisting essentially of”, where one of these three terms is used herein, the presently disclosed and claimed subject matter can include the use of either of the other two terms.

As used herein, the term “and/or” when used in the context of a listing of entities, refers to the entities being present singly or in combination. Thus, for example, the phrase “A, B, C, and/or D” includes A, B, C, and D individually, but also includes any and all combinations and subcombinations of A, B, C, and D.

The terms “epoxy”, “epoxide” and “oxirane” as used herein refer to chemical functional group comprising a three-membered ring structure comprising one oxygen atom and two carbon atoms that are bonded together via single bonds. Thus, an epoxy group can have the structure:

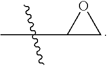 [SMILES: *C1CO1]

The term “silyl” refers to groups comprising silicon atoms (Si).

The term “silane” refers to a molecule comprising a silicone atom.

As used herein, the terms “siloxy” and “silyl ether” refer to groups or compounds including a silicon-oxygen (Si—OR) bond and wherein R is an organic group, such as a substituted or unsubstituted alkyl or aryl group (i.e., methyl, ethyl, phenyl, etc.). In some embodiments, the terms refer to compounds comprising one, two, three, or four alkoxy, aralkoxy, or aryloxy groups bonded to a silicon atom. Each alkyloxy, aralkoxy, or aryloxy group can be the same or different.

As used herein, a “monomer” refers to a molecule that can undergo polymerization, thereby contributing constitutional units, i.e., an atom or group of atoms, to the essential structure of a macromolecule.

As used herein, the term “monomeric isocyanate” refers to non-polymeric molecules that comprise two or more polymerizable functional groups. For example, monomeric isocyanates typically include two or more isocyanate functional groups (i.e., are monomeric polyisocyanates). Example monomeric isocyanates include, but are not limited to aliphatic and aromatic diisocyanates, such as, 1,6-hexamethylene diisocyanate (HDI), isophorane diisocyanate (IDI), 4,4-diphenylmethane diisocyanate (MDI), toluene diisocyanate, xylene diisocyanate, and the like.

As used herein, a “macromolecule” refers to a molecule of high relative molecular mass, the structure of which comprises the multiple repetition of units derived from molecules of low relative molecular mass, e.g., monomers and/or oligomers.

An “oligomer” refers to a molecule of intermediate relative molecular mass, the structure of which comprises a small plurality (e.g., 2, 3, 4, 5, 6, 7, 8, 9, or 10) of repetitive units derived from molecules of lower relative molecular mass.

A “polymer” refers to a substance comprising macromolecules. In some embodiments, the term “polymer” can include both oligomeric molecules and molecules with larger numbers (e.g., >10, >20, >50, >100) of repetitive units. In some embodiments, “polymer” refers to macromolecules with at least repetitive units.

A “copolymer” refers to a polymer derived from more than one species of monomer.

As used herein, a “block macromolecule” refers to a macromolecule that comprises blocks in a linear sequence. A “block” refers to a portion of a macromolecule that has at least one feature that is not present in the adjacent portions of the macromolecule. A “block copolymer” refers to a copolymer in which adjacent blocks are constitutionally different, i.e., each of these blocks comprises constitutional units derived from different characteristic species of monomer or with different composition or sequence distribution of constitutional units.

A “chain” refers to the whole or part of a macromolecule, an oligomer, or a block comprising a linear or branched sequence of constitutional units between two boundary constitutional units, wherein the two boundary constitutional units can comprise an end group, a branch point, or combinations thereof.

As used herein, the term “room temperature” is considered to be any temperature between about 15° C. and about 25° C. (i.e., about 15, 16, 17, 18, 19, 20, 21, 22, 23, 24, or about 25° C.). In some embodiments, the term “room temperature” is a temperature between about 18° C. and about 24° C. or between about 20° C. and about 25° C.

### II. Cold Bonding Adhesives

Room temperature bonding (Cold Bonding or “CB”) of vulcanized elastomers to various metal substrates and elastomers is in high demand. There are many applications where assets are too large in dimension to fit into a press or autoclave, which causes a need for adhesives that can cure at ambient temperatures (e.g., room temperature). However, many traditional adhesives are not effective at such low temperatures and current cold bonding adhesives on the market typically contain hazardous chemicals. As disclosed herein, one-component (1K) CB adhesives have been developed that, without sacrificing performance, do not contain any high concerning regulatory chemicals. For example, the presently disclosed CB adhesives can be provided in compositions with solvents such as tert-butyl acetate or other non-chlorinated solvents and can be free of monomeric isocyanates. The presently disclosed 1K cold bonding adhesives bond vulcanized elastomers, such as chloroprene and buffed natural rubber (commonly difficult to bond) to themselves (i.e., to the same vulcanized elastomer or to a different type of vulcanized elastomer) or to metals, such as primed grit blasted steel surfaces, with the possibility of metal primer free application. If a metal primer is used, the presently disclosed adhesives have great compatibility with a wide range of standard primers, including, but not limited to CHEMLOK® 205 and other primers sold under the tradename CHEMLOK® (Lord Corporation, Cary, North Carolina, United States of America). The presently disclosed 1K adhesive platform works faster without any required hardener, is easier to use with longer pot-life, and has a wider range of tack-times in comparison to traditional two-component (2K) systems. In addition to application advantages, it is also safer since it is based on environmentally preferred chemistry with no known carcinogenic substances. Moreover, it ensures high performance since it is designed to develop maximum green strength after 1 hour of drying with the ability to re-gain strength with solvent re-tack (open time) after complete dryness. Since volatile organic solvents can adversely affect the ecosystem and human health in numerous ways, the presently disclosed subject matter also discloses a 2K aqueous adhesive for cold bonding applications. Both the presently disclosed 1K solvent and 2K aqueous CB adhesives reach a peal strength of 40 PLI after just 7 days of bonding at room temperature.

In some embodiments, the presently disclosed subject matter provides a CB adhesive composition (e.g., a 1K or 2K adhesive) comprising a halogenated base polymer selected from a halogenated elastomer or a halogenated natural or synthetic rubber, wherein the CB adhesive composition is free of monomeric isocyanates and/or can be provided for use without hazardous solvents. Thus, in some embodiments, the CB adhesive composition or formulation thereof is free of TCE and/or other chlorinated solvents.

Suitable halogenated base polymers include, but are not limited to, chlorinated elastomers, fluoroelastomers, chlorinated natural rubber, and chlorine- and bromine-containing synthetic rubbers, such as polychloroprene, chlorinated polychloroprene, chlorinated polybutadiene, bromobutyl rubber, hexachloropentadiene, chlorinated butadiene styrene copolymers, chlorinated ethylene propylene copolymers, ethylene/propylene/non-conjugated diene terpolymers, chlorinated polyethylene, chlorosulfonated polyethylene, brominated poly(2,3-dichloro-1,3-butadiene), copolymers of α-chloroacrylonitrile and 1,2-dichloro-1,3-butadiene, chlorinated poly(vinyl chloride), and mixtures thereof. In some embodiments, the halogenated base polymer is a chlorinated elastomer or a chlorinated natural or synthetic rubber. In some embodiments, the chlorinated base polymer comprises a neoprene (i.e., polychloroprene) rubber or neoprene latex. In some embodiments, the halogenated (e.g., chlorinated) base polymer can provide compatibility with vulcanized rubber/elastomer substrates.

The CB adhesives can further comprise a rubber curative agent and an adhesion promoter. In some embodiments, the rubber curative agent is a metal oxide, such as zinc oxide, magnesium oxide, or a mixture of zinc oxide and magnesium oxide.

Suitable adhesion promoters include compounds having a group that adheres to or reacts with a vulcanized rubber/elastomer substrate and/or a group that adheres to a metal substrate. Suitable adhesion promoters (e.g., for primer-less applications) include, but are not limited to, epoxy functional silanes, amine functional silanes (e.g., aminopropyltrimethoxyethoxysilane, aminopropyltrimethoxysilane, or aminoethylaminopropyltrimethoxysilane), acid functional silanes, ureido silanes (e.g., ureidopropyltrimethoxysilane), mercapto silanes, silane-terminated polymers, and hydroxyethylmethacrylate acid phosphate (i.e., HEMA phosphate). In some embodiments, the adhesion promoter is an epoxy functional silane. Examples of suitable epoxy functional silane compounds include, but are not limited to, 3-glycidoxypropyltrimethoxysilane, 3-glycidoxypropyldimethoxysilane, 3-glydicoxypropyldimethylmethoxysilane, 2-(3,4-epoxycyclohexyl)-ethyltrimethoxysilane, and the like. Such compounds are generally available commercially (for example, 3-glycidoxypropyltrimethoxysilane is available from Aldrich Chemical (part of MillaporeSigma, St. Louis, Missouri, United States of America) and 3-glycidoxypropyltrimethoxysilane and beta-(3,4-epoxycyclohexyl)-ethyltrimethoxysilane are available from Gelest Inc. (Morrisville, Pennsylvania, United States of America)) and many of such compounds are known in the literature and/or are obtainable by art-recognized procedures. In some embodiments, the epoxy silane is (3-glycidyloxypropyl)triethoxysilane (GPTES), also known as gamma-glycidoxypropyltrimethoxy silane (sold under the tradename SILQUEST A-187® (Momentive Performance Materials, Waterford, New York, United States of America).

Accordingly, in some embodiments, the cold bonding adhesive composition comprises a chlorinated base polymer selected from a chlorinated elastomer and a chlorinated natural or synthetic rubber; a rubber curative agent selected from zinc oxide, magnesium oxide, or a mixture thereof; and an adhesion promoter, optionally wherein the adhesion promoter is a silane; and wherein the cold bonding adhesive is free of monomeric isocyanates and/or TCE.

In some embodiments, the cold bonding adhesive is a one-component (1K) adhesive comprising a halogenated base polymer (e.g., neoprene rubber), a rubber curative agent, and an adhesion promoter. In some embodiments, the 1K adhesive is free of monomeric isocyanates and is free of TCE. In some embodiments, the adhesive comprises about 60 weight % (wt %) to about 80 wt % of the chlorinated base polymer (based on the total dry (i.e., solvent-free) weight of the adhesive); about 3.0 wt % to about 6.0 wt % of the rubber curative (based on the total dry weight of the adhesive); and about 2.0 wt % to about 6.0 wt % of the adhesion promoter (based on the total dry weight of the adhesive).

In some embodiments, the adhesive further comprises one or more additional halogenated (e.g., chlorinated) base polymer. The one or more additional halogenated base polymer can be selected, for example, to provide compatibility with a metal primer intended for use in a bonding application and/or for adhesive cohesiveness. In some embodiments, the one or more additional halogenated base polymer is another halogenated polymer as described above for the halogenated base polymer. Additional base polymers can also include halogenated (e.g., chlorinated) polyol fines, such as, but not limited to halogenated (e.g., chlorinated) polypropylene and halogenated (e.g., chlorinated) polyurethane. In some embodiments, the one or more additional halogenated base polymer comprises one or more additional chlorinated base polymer. In some embodiments, the one or more additional chlorinated base polymer is selected from a chlorinated elastomer, a chlorinated natural or synthetic rubber, and chlorinated polyol fines.

In some embodiments, the cold bonding adhesive further comprises one or more coloring agent. Suitable coloring agents include both organic and inorganic pigments. In some embodiments, the coloring agent is carbon black.

In some embodiments, the adhesive further comprises a rheology modifier. In some embodiments, the rheology modifier can be selected to provide anti-settling, thickening, and/or sag resistance. Suitable rheology modifiers include, but are not limited to, silica (e.g., fumed silica powders); treated clays, such as montmorillonite; and mixtures thereof. In some embodiments, the rheology modifier is a fumed silica powder.

In some embodiments, the adhesive further comprises one or more water scavengers. Suitable water scavengers include, but are not limited to vinyltrimethoxysilane, p-toluenesulfonyl isocyanate (PTSI), a zeolite (e.g., a zeolite powder), and a nanoclay (e.g., an organonanoclay).

Thus, in some embodiments, the 1K adhesive comprises a chlorinated base polymer, a rubber curative agent, an adhesion promoter and one or more (e.g., one, two, three, four, or five of) additional components selected from the group comprising one or more additional halogenated base polymer, one or more coloring agent, one or more rheology modifier, and one or more water scavenger. In some embodiments, the adhesive comprises (based on the total dry weight of the adhesive): (a) about 60 weight % (wt %) to about 80 wt % of the chlorinated base polymer (e.g., about 60, 62, 64, 66, 68, 70, 72, 74, 76, 78, or about 80 wt % of the chlorinated base polymer); (b) about 10 wt % to about 20 wt % of one or more additional chlorinated base polymer (e.g., about 10, 11, 12, 13, 14, 15, 16, 17, 18, 19, or about 20 wt % of the one or more additional chlorinated base polymer); (c) about 0.5 wt % to about 3.0 wt % of a colorant (e.g., about 0.5, 1.0, 1.5, 2.0, 2.5, or about 3.0 wt % of a colorant); (d) about 4.0 wt % to about 10 wt % of a rheology modifier (e.g., about 4.0, 4.5, 5.0, 5.5, 6.0, 6.5, 7.0, 7.5, 8.0, 8.5, 9.0, 9.5 or about 10 wt % of a rheology modifier); (e) about 3.0 wt % to about 6.0 wt % of the rubber curative agent (e.g., about 3.0, 3.5, 4.0, 4.5, 5.0, 5.5, or about 6.0 wt % of the rubber curative agent); (f) about 3.0 wt % to about 6.0 wt % of vinyltrimethoxysilane or PTSI (e.g., about 3.0, 3.5, 4.0, 4.5, 5.0, 5.5, or about 6.0 wt % of vinyltrimethoxysilane or PTSI); (g) about 3.0 wt % to about 6.0 wt % of a zeolite powder or an organonanoclay (e.g., about 3.0, 3.5, 4.0, 4.5, 5.0, 5.5, or about 6.0 wt % of a zeolite powder or an organonanoclay); and (h) about 2.0 wt % to about 6.0 wt % of the adhesion promoter (e.g., about 2.0, 2.5, 3.0, 3.5, 4.0, 4.5, 5.0, 5.5, or about 6.0 wt % of the adhesion promoter).

In some embodiments, the adhesive can further comprise one or more additional additives, e.g., to improve metal adhesion. Such additives can comprise one or more chemical functional group that can interact with metals, such as silane, phosphate, and hydroxyl groups. In some embodiments, the one or more additional additives can be selected from one or more additional silanes, a polyurethane, HEMA-phosphate, and/or a phenolic resin.

In some embodiments, the 1K adhesive further comprises one or more solvents (e.g., one or more non-halogenated solvents) or is provided as a composition (e.g., a solution or suspension) further comprising one or more solvents. Suitable solvents include non-chlorinated solvents, such as ethyl acetate, butyl acetate, tert-butyl acetate (TBAc), propyl acetate, amyl acetate, isoamyl acetate, dioxane, dimethyl carbonate, cyclohexanone or methyl isopropyl ketone (MIPK) methyl ethyl ketone (MEK), a C8-C9 isoparaffinic hydrocarbon solvent, benzene, hexane, cyclohexane, heptane, toluene, xylenes, and perfluorinated solvents. For example, in some embodiments, the one or more solvents are selected from an ester solvent, such as TBAc; an aromatic solvent, such as toluene or xylenes; or any mixture thereof. In some embodiments, the one or more solvents are a mixture of TBAc and xylenes. In some embodiments, the one or more solvents are free of aromatic solvents. In some embodiments, the 1K adhesive further comprises one or more solvents comprising or consisting of TBAc. In some embodiments, the 1K adhesive comprises about 7 parts by weight of one or more solvents and about 3 parts by weight solids. The solids can comprise a mixture of the other, non-solvent adhesive components (e.g., the base polymer, one or more additional base polymer, colorant, rheology modifier, rubber curative agent, water scavenger(s), and adhesion promoter). Thus, in some embodiments, the composition is an 1K adhesive composition comprising about 15 wt % to about 30 wt % solids (i.e., wherein the solids comprise the chlorinated base polymer, rubber curative agent, adhesion promoter, and one or more optional components selected from an additional halogenated base polymer, a coloring agent, a rheology modifier, a water scavenger, and the other additional additives described herein).

In some embodiments, the presently disclosed cold bonding adhesive is provided as a two-component (2K) adhesive. In some embodiments, the 2K adhesive is an aqueous adhesive, i.e., where one or both components comprise an aqueous solvent and/or wherein the adhesive is free of non-aqueous solvents. In some embodiments, the 2K adhesive is free of chlorinated solvents (e.g., free of TCE). In some embodiments, the adhesive comprises a first component (or “A-side”) and a second component (or “B-side”) that are kept separate until the time the adhesive is ready to be used.

In some embodiments, the presently disclosed cold bonding adhesive is a 2K adhesive and a chlorinated base polymer, a rubber curative agent, and an adhesion promoter are each present in a first component of the 2K adhesive. Suitable chlorinated base polymers, rubber curative agents, and adhesion promoters include those described above. In some embodiments, the chlorinated base polymer is neoprene latex. In some embodiments, the adhesion promoter is an epoxy silane. In some embodiments, the rubber curative agent is zinc oxide.

In some embodiments, the first component (i.e., the “A-side) further comprises one or more additional compounds/agents, such as, but not limited to, a colorant, a defoamer, a rheology modifier, a thickening agent, a surfactant, and a tackifier. In some embodiments, the first component comprises a colorant (e.g., an organic or inorganic pigment). In some embodiments, the colorant is carbon black. In some embodiments, the first component further comprises one or more of a surfactant, a tackifier, a rheology modifier, and a defoamer. Suitable surfactants include, but are not limited to, nonionic surfactants, such as sorbitan ester surfactants, e.g., monostearate, monolaurate, tristearate, monopalmitate or polyoxyethylene esters of sorbitol. Suitable tackifiers include aliphatic hydrocarbon resins, aromatic modified aliphatic hydrocarbon resins, hydrogenated polycyclopentadiene resins, polycyclopentadiene resins, gum rosins, gum rosin esters, terpenes, and the like. In some embodiments, the tackifier is a hydrocarbon resin. In some embodiments, the thickener is a modified urea. In some embodiments, the defoamer is a biodegradable defoamer. The first component can further comprise a pH control agent, such as an alkali metal hydroxide (e.g., NaOH or KOH) or an alkali metal carbonate.

The first component (i.e., the “A-side”) can further comprise an aqueous solvent (e.g., deionized water). In some embodiments, the first component comprises about 70 wt % to about 75 wt % solids. In some embodiments, the first component is free of an organic solvent.

In some embodiments, the second component (i.e., the “B-side”) of the 2K adhesive comprises a water-dispersible polyisocyanate. In some embodiments, the second component is free of an organic solvent. In some embodiments, the second component comprises 100% water-dispersible polyisocyanate (i.e., the second component is a water-dispersible, solvent-free polyisocyanate). Water-dispersible polyisocyanates are known in the art. In some embodiments, the water-dispersible polyisocyanate can be an aliphatic or a cycloaliphatic polyisocyanate or a mixture thereof. In some embodiments, the water-dispersible polyisocyanate is a polyisocyanate modified by a cationic, anionic or non-ionic hydrophilic group, such as a polyether. Suitable water-dispersible polyisocyanates include, but are not limited to, those described in U.S. Pat. Nos. 4,663,377 and 5,200,489, the disclosures of which are incorporated by reference in their entireties.

In some embodiments, the presently disclosed subject matter provides a method of bonding two substrates using a CB adhesive as disclosed herein (e.g., a 1K adhesive as described herein, such as, but not limited to, a 1K adhesive that is dissolved in or further comprises one or more solvents, such as TBAc and/or xylenes, or a 2K adhesive as described herein). In some embodiments, the method is a method of bonding a vulcanized elastomer (e.g., a vulcanized rubber substrate) to a second substrate, wherein the second substrate comprises a second vulcanized elastomer substrate or a metal substrate. Example vulcanized elastomers include, but are not limited to, vulcanized natural rubber (NR), vulcanized butadiene rubber (BR), vulcanized chloroprene rubber (CR), vulcanized styrene butadiene rubber (SBR), vulcanized nitrile rubber (NBR), vulcanized NR/BR blends, and vulcanized SBR/BR blends. In some embodiments, the second substrate is a second vulcanized elastomer. In some embodiments, the second substrate is a metal substrate (e.g., steel or aluminum).

In some embodiments, the method comprises: (i) applying a cold bonding adhesive of the presently disclosed subject matter (e.g., a 1K adhesive or a 2K aqueous adhesive composition) to a surface of one or both of the vulcanized elastomer substrate and the second substrate, thereby providing at least one adhesive-coated surface; (ii) contacting the vulcanized elastomer substrate to the second substrate wherein the at least one adhesive-coated surface is present between the vulcanized elastomer substrate and the second substrate; and (iii) curing the adhesive. In some embodiments, the cold bonding adhesive is applied to a surface of both the vulcanized elastomer substrate and the second substrate. In some embodiments, the cold bonding adhesive is applied to the substrate surface via brush or roll application. In some embodiments, one layer of adhesive is applied to the substrate surface. In some embodiments, multiple layers (e.g., 2, 3, 4, 5, 6, or more) layers of adhesive are applied to a substrate surface.

In some embodiments, the adhesive coated surface or surfaces are dried prior to contact with the other substrate. In some embodiments, the drying can be performed under ambient conditions (e.g., at room temperature) for about 5 to about 15 minutes per layer of adhesive. The amount of drying time can be varied depending upon the number of adhesive layers applied. When there is only one layers, a 5-minute dry time can be sufficient. When more layers are used, a longer drying time can be employed between layer applications. In some embodiments, further drying (e.g., for one hour at room temperature) can be conducted after application of the final adhesive coat. If the adhesive-coated surface is not sufficiently tacky after drying, solvent can be re-applied and partial drying can be performed to regain tack.

In some embodiments, one or both substrates can be cleaned and/or buffed prior to application of the adhesive or prior to contact with an adhesive-coated surface. In some embodiments, one or both substrates can be contacted with a primer prior to application of the adhesive or contact with an adhesive-coated surface.

Curing of step (iii) can be performed under ambient conditions (e.g., at room temperature) In some embodiments, the adhesive is allowed to cure for about 7 to about 21 days.

In some embodiments, the presently disclosed subject matter provides a bonded assembly prepared according to method as described herein or using an adhesive composition as described herein. In some embodiments, the bonded assembly comprises a first substrate comprising a vulcanized elastomer bonded to a second substrate with a cured CB adhesive of the presently disclosed subject matter (e.g., a cured adhesive formed by curing a composition comprising a chlorinated based polymer, a rubber curative agent, and an adhesion promoter). In some embodiments, the second substrate is a second vulcanized elastomer (which can have the same chemical composition or a different chemical composition from the first substrate). In some embodiments, the second substrate is a metal substrate (e.g., a steel substrate).

In some embodiments, the presently disclosed adhesive can be used to provide a bonded assembly and/or the presently disclosed method can provide a bonded assembly having a peal strength of about 35 PLI or more or of about 40 PLI or more after 7 days of curing at room temperature. In some embodiments, the peal strength is about 45 PLI, about 50 PLI, or about 55 PLI or more after 7 days. In some embodiments, the peal strength is about 45, about 50, about 55, about 60, about 65, about 70, about 75, about 80, about 85, about 90, or about 95 PLI after 21 days of curing at room temperature.

In some embodiments, the presently disclosed adhesives are provided for use in applications related to high cycle fatigue items. In some embodiments, the applications are selected from mining tanks, equipment, and assemblies; rubber roofing and/or flooring; tires; shock absorbers; and applications involving remote site repairs.

### EXAMPLES

The following examples are included to further illustrate various embodiments of the presently disclosed subject matter. However, those of ordinary skill in the art should, in light of the present disclosure, appreciate that many changes can be made in the specific embodiments which are disclosed and still obtain a like or similar result without departing from the spirit and scope of the presently disclosed subject matter.

### Example 1

Table 1, below, summarizes the components of an example 1K cold bonding adhesive of the presently disclosed subject matter.

TABLE 1
Composition of 1K CB Adhesive (Composition 0302-2).

| | | | | Dry | | % Wet | |
|---|---|---|---|---|---|---|---|
| | Materials | Description | % TSC | Wt. | % Dry | Wt | Batch |
| 1 | Neoprene rubber | Base polymer | 100.00 | 21.00 | 70.000 | 21.00 | 21.00 |
| 2 | Chlorinated rubber | Base polymer | 100.00 | 3.30 | 11.000 | 3.30 | 3.30 |
| 3 | Carbon black | Color | 100.00 | 0.30 | 1.000 | 0.30 | 0.30 |
| 4 | Fumed silica powder | Rheology | 100.00 | 1.50 | 5.000 | 1.50 | 1.50 |
| | | modifier | | | | | |
| 5 | Zinc Oxide | Curative | 100.00 | 0.90 | 3.000 | 0.90 | 0.90 |
| 6 | Vinyltrimethoxysilane | Water | 100.00 | 0.90 | 3.000 | 0.90 | 0.90 |
| | | scavenger | | | | | |
| 7 | Zeolite powder | Water | 100.00 | 1.50 | 5.000 | 1.50 | 1.50 |
| | | scavenger | | | | | |
| 8 | Epoxy silane | Adhesion | 100.00 | 0.60 | 2.000 | 0.60 | 0.60 |
| | | promoter | | | | | |
| 9 | | | | | | | |
| 10 | TBAc | Solvent | 0.00 | 0.00 | 0.00 | 23.45 | 23.45 |
| 11 | Xylene | | 0.00 | 0.00 | 0.00 | 46.55 | 46.55 |

| | | | | |
|---|---|---|---|---|
| Totals | 30.0 | 100.00 | 100.0 | 100.00 |

More particularly, the neoprene rubber and chlorinated polymers used in the composition were the polymers sold under the tradenames BAYPREN® 310-1 (Arlanxeo Deutschland GmbH, Dormagen, Germany) and PERGUT® S170 (Covestro AG, Leverkusen, Germany), respectively. The carbon black was a product sold under the tradename RAVEN® 14 carbon black (Columbian Chemicals Co., Marietta Georgia). The fumed silica powder was a powder sold under the tradename CAB-O-SIL® (Cabot Corporation, Billerica, Massachusetts, United States of America). The zinc oxide used was sold under the tradename ZUCO 102 (Zochem Inc., Brampton, Canada). The zeolite powder was a powder sold under the tradename PURMOL™ (Zochem Inc., Brampton, Canada). The epoxy silane was gamma-glycidoxypropyltrimethoxy silane (sold under the tradename SILQUEST A-187® (Momentive Performance Materials, Waterford, New York, United States of America). The composition used TBAc and xylenes as co-solvents. In some embodiments, the xylenes can be omitted and the composition can be free of aromatic solvents.

In addition, an example 2K GB adhesive was prepared. The components of the A-side of the 2K GB adhesive are described hereinbelow in Table 2.

TABLE 2
Composition of Aqueous A-side of 2K CB Adhesive (Composition 713).

| | | | | Dry | | % Wet | |
|---|---|---|---|---|---|---|---|
| | Materials | Description | % TSC | Wt. | % Dry | Wt | Batch |
| 1 | Neoprene latex | Base polymer | 56.60 | 303.40 | 76.000 | 53.71 | 375.97 |
| 2 | Carbon Black | Color | 100.00 | 0.40 | 1.000 | 0.40 | 2.80 |
| 3 | Fumed silica powder | Rheology | 100.00 | 4.00 | 10.000 | 4.00 | 28.00 |
| | | modifier | | | | | |
| 4 | Zinc Oxide | Curative | 100.00 | 1.20 | 3.000 | 1.20 | 8.40 |
| 5 | Modified urea | Thickening | 40.00 | 0.20 | 0.500 | 0.50 | 3.50 |
| | | agent | | | | | |
| 6 | Ionic polyacrylic | Defoamer | 52.00 | 0.20 | 0.500 | 0.38 | 2.69 |
| | copolymer | | | | | | |
| 7 | Biodegradable vegetable- | Rheology- | 100.00 | 0.20 | 0.500 | 0.20 | 1.40 |
| | based defoamer | leveling and | | | | | |
| | | wetting | | | | | |
| 8 | Sorbitan monostearate | Surfactant/ | 9.85 | 0.80 | 2.000 | 8.12 | 56.85 |
| | | stabilizer | | | | | |
| 9 | Polyoxyethylenesorbitan | Surfactant/ | 100.00 | 0.20 | 0.500 | 0.20 | 1.40 |
| | monopalmitate | stabilizer | | | | | |
| 10 | Epoxy silane | Adhesion | 100.00 | 1.20 | 3.000 | 1.20 | 8.40 |
| 11 | Hydrocarbon resin | Tackifier | 100.00 | 0.80 | 2.000 | 0.80 | 5.60 |
| 12 | NaOH | pH control | 100.00 | 0.40 | 1.000 | 0.40 | 2.80 |
| 15 | DI water | Solvent | 0.00 | 0 | 27.44 | 27.44 | 192.07 |
| 16 | DowPM | Solvent | 0.00 | 0 | 1.44 | 1.44 | 10.11 |
| 17 | Co-solvent | Solvent | 0.00 | 0 | 0.00 | 0.00 | 0.00 |

| | | | | |
|---|---|---|---|---|
| Totals | 40.0 | 100.00 | 100.0 | 700.00 |

The same carbon black and zinc oxide were used in the 2K A-side as in the example 1K composition. The fumed silica powder was CAB-O-SIL® M5 (Cabot Corporation, Billerica, Massachusetts, United States of America). The modified urea, ionic polyacrylic copolymer, and biodegradable defoamers were products sold under the tradenames BYK© 7420, BYK®-381, and BYK® 1740 (BYK-Chemie GmbH, Wessel, Germany), respectively. The sorbitan monostearate and polyoxyethylenesorbitan monopalmitate were surfactants sold under the tradenames SPAN® 60 and TWEEN® 40 (Croda International PLC, Snaith, United Kingdom). The hydrocarbon resin was a resin sold under the tradename REGALREZ® 1018 (Eastman Chemical Resins, Kingsport, Tennessee, United States of America). The B side was 100% water-dispersible polyisocyanate.

### Example 2

### Adhesive Bonding Performance: Seam Bonding

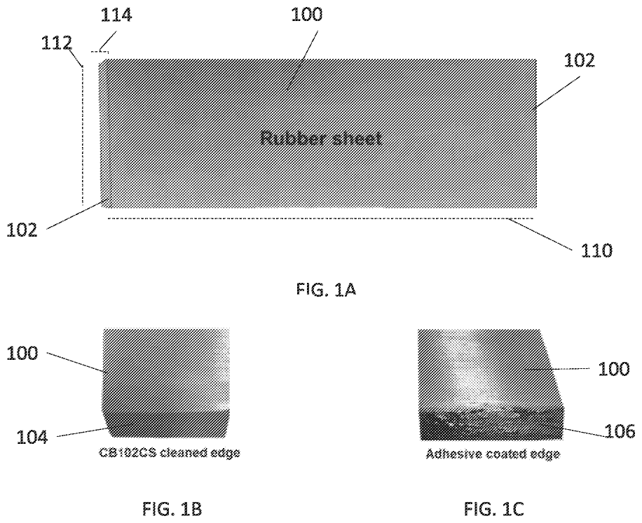

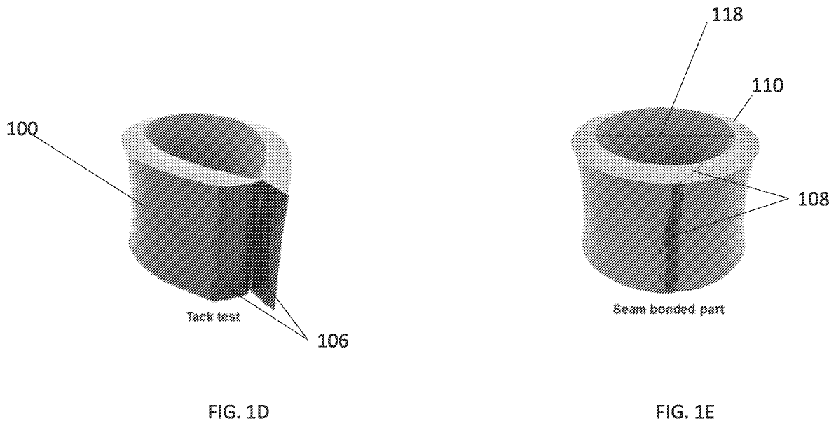

Seam bonding can refer to the process of bonding the edges of a sheet of vulcanized rubber together to form a cylinder or cyclone shape. FIGS. 1A-1E show an example seam bonding process used to simulate seam bonding in the field and for use in testing the presently disclosed adhesives. FIG. 1A shows rubber sheet 100 with length 110 of 12 inches, width 112 of 3 inches and height 114 of 0.5 inches. Edges 102 of rubber sheet 100 are cut at a 45° angle to provide a larger surface area for bonding. Edges 102 are buffed and then cleaned with an adhesion enhancer/surface modifier (CB102CS, Lord Corporation, Cary, North Carolina, United States of America) by saturating a rag and wiping the surface of the 45® edges, thereby providing, on each end of rubber sheet 100 of FIG. 1A, cleaned edge 104. See FIG. 1B. In some embodiments, the adhesion enhancer/surface modifier can increase the polarity of the surface. Once the adhesion enhancer/surface modifier has dried, the adhesive is applied via brush or roll application to provide, on each end of rubber sheet 100 of FIG. 1A, adhesive coated edge 106. See FIG. 1C. Brush application is using a brush to apply the adhesive onto the rubber surface with back and forth strokes to completely cover the surface with a uniform layer of adhesive. The unique performance characteristic of the presently disclosed technology is that, once the two coated edges, after drying, are mated together, an instantaneous self-standing seam bond is achieved without using external tools to hold it in-place. See FIGS. 1D and 1E. More particularly, FIG. 1D shows rubber sheet 100 configured to bring adhesive coated edges 106 into alignment with one another at the beginning of the bonding process. As shown in FIG. 1E, after bonding, rubber sheet 100 forms a cylinder with inner diameter 118 of 3 inches and seam bond 108. One thin layer of adhesive would be sufficient for instantaneous seam bonding after about 5 min of drying, depending on the temperature of the environment. However, for harsh applications, multiple layers of adhesive are recommended and that would require about 15 minutes dry time in between. This can take up to about 1 to about 1.5 hours of overall drying before seaming. Use the knuckle test, by pressing down with your knuckle until the material does not stick. For working only on one part at a time, paying attention to the dry time of the adhesive can be helpful to hit the sweet-spot of instantaneous seam bonding, which is the point of super-tack. But for assembling of a large amount of parts, the adhesive is allowed to dry for an extended amount of time (up to about 24 h). Then, the dried surfaces are re-tacked gently with a wet rag of solvent (MEK or xylene or toluene), followed by partial drying of about 15 to about 20 minutes to regain the surface tackiness.

### Example 3

### Adhesive Bonding Performance: Rubber to Metal Bonding (RTM)

Performance of RTM bonding, known as bulk performance, has been tested under different conditions. To simulate bonding in the field, a metal coupon of the following dimensions: L2.5 inches×W1 inches was used. The metal substrate is blasted to a 1-3 mil profile and then cleaned with solvent (MEK) using lint-free wipes to remove any dust. The metal surfaces are then taped so that a 1-inch bond area is exposed. When the metal surface has dried, primer is applied to a target film thickness of 0.3-0.5 mil. The rubber is wiped with an adhesion enhancer/surface modifier (CB102CS, Lord Corporation, Cary, North Carolina, United States of America) and then taped for a 1-inch bond area. Once the rubber surface has dried, two coats of the adhesive are applied via brush to both the metal and rubber bonding areas with at least 15 minutes of dry time between coats. Parts are left to dry at room temperature for at least one hour. The knuckle test is used to determine if the adhesive is dry enough for mating. If the adhesive is too dry, retack with solvent to regain the right surface tack. Parts are then mated and left to cure for the required time of 7 and 21 days.

### Example 4

### Metal Primer Comparisons

Various concentrations of a primer sold under the tradename CHEMLOK® 205 primer (Lord, Corporation, Cary, North Carolina, United States of America) were tested on grit blasted (GB) steel as a primer for use with the example 1K CB adhesive described above. Data are summarized in Table 3, below. 35 pounds per linear inch (PLI) after 21 day is typically accepted strength for CB rubber to metal. After 7 days of bonding, all CHEMLOK® 205 concentrations showed over 35 PLI. The concentration did not show any a significant role on PLI. However further cleaning of the metal substrate with wiping the surface with MEK (as described in the section above) provided the highest bond strength PLI values (over 100 pounds (lb)). Without being bound to any one theory, this is attributed to the elimination of greases and contaminants from the metal surface. After 21 days of bonding, more improvement on PLI was observed due to further dry/cure of the adhesive system.

TABLE 3
PLI vs CHEMLOK ® 205 concentration

| | Adhesive | | | | | | | | | |
|---|---|---|---|---|---|---|---|---|---|---|
| | 1K 308-2 | | | | | | | | | |
| | Primer | | | | | | | | | |
| | CH205 | | | | | | | | | |
| | Metal Prep | | | | | | | | | |
| | | | | | | | | | Fresh GB and MEK wipe with | |
| | Fresh GB and Air cleaning | | | | | | | | lint-fee rag | |
| | Primer drying time | | | | | | | | | |
| | 1 h | | | | | | | | 1 h | |
| | Primer Conc. | | | | | | | | | |
| | 25% | | 50% | | 100% | | 200% | | 100% | |
| Cure time (days) | 7 | 21 | 7 | 21 | 7 | 21 | 7 | 21 | 7 | 21 |
| PLI | 56 | 85 | 49 | 50 | 50 | 70 | 50 | 83 | 68 | 93 |

The primer sold under the tradename CHEMLOK® 207 (Lord Corporation, Cary, North Carolina, United States of America) is another primer option, which is used for harsh environments in conventional systems, was also tested under different primer drying conditions. Data are summarized in Table 4, below. Sufficient drying time is needed to avoid resolvation of the primer layer, however, about 30 minutes looks to be sufficient based on the data in Table 4. High PLI still can be achieved. CHEMLOK® 207 showed comparable bond performance results to CHEMLOK® 205.

TABLE 4
CH205 vs CH207 concentration

| | Adhesive | | | | | | | | | | | |
|---|---|---|---|---|---|---|---|---|---|---|---|---|
| | 1K 308-2 | | | | | | | | | | | |
| | Metal Prep | | | | | | | | | | | |
| | Grit blast, followed by air cleaning | | | | | | | | | | | |
| | Primer | | | | | | | | | | | |
| | CH205 | | | | | | CH207 | | | | | |
| | Primer Conc. | | | | | | | | | | | |
| | Full strength | | | | | | Full Strength | | | | | |
| | Primer Drying Time | | | | | | | | | | | |
| | 30 min | | 1 h | | 2 h | | 30 min | | 1 h | | 2 h | |
| Cure time | 7 | 21 | 7 | 21 | 7 | 21 | 7 | 21 | 7 | 21 | 7 | 21 |
| (days) | | | | | | | | | | | | |
| PLI | 64 | 96 | 50 | 70 | 57 | 85 | 45 | 80 | 59 | 61 | 38 | 74 |

### Example 5

### Bonding Various Rubber Compounds

To show the broad performance ability of the presently disclosed 1K system, various rubber compounds from different suppliers were tested. The adhesive was applied in the same manner as for the comparative primer studies described in Example 3. Two coats of adhesive were applied to both the rubber and the metal, after the metal was primed and the rubber cleaned with CB102CS (Lord Corporation, Cary, North Carolina, United States of America), allowing a 15-minute dry time between coats. Data are summarized in Table 5, below.

As shown in Table 5, the 1K adhesive composition showed Although this 1K 308-good bulk bonding performance with a primed metal substrate. It is expected that a 1K adhesive composition that would give the same performance without a primer can be prepared by adding one or more additives, such as silanes, polyurethanes (PUs), phosphoric acid 2-hydroxyethyl methacrylate ester (HEMA-phosphate) and phenolic resin to the base 1K formulation to improve adhesion to a unprimed metal substrate.

TABLE 5
Rubber Compound Comparison / Compatibility with 1K 308-2

| | Adhesive | | | | | | | | | | | | | |
|---|---|---|---|---|---|---|---|---|---|---|---|---|---|---|
| | 1K 308-2 | | | | | | | | | | | | | |
| | Primer | | | | | | | | | | | | | |
| | CH205 | | | | | | | | | | | | | |
| | Layers number | | | | | | | | | | | | | |
| | | | | | | | | | RM | | AM | | AM | |
| | | | Metso | | Blair | | | | Built | | Built | | Built | |
| | | | Brown- | | Black- | | | | Right | | Right | | Right | |
| | Steuler- | | on | | on | | Rubber | | Gray- | | Natural | | Red- | |
| | KCH | | black | | white | | Source | | on red | | Rubber | | on red | |
| Cure time | 7 | 21 | 7 | 21 | 7 | 21 | 7 | 21 | 7 | 21 | 7 | 21 | 7 | 21 |
| (days) | | | | | | | | | | | | | | |
| PLI | 20 | 35 | 32 | 45 | 40 | 47 | 25 | 35 | 59 | 77 | 38 | 46 | 65 | 76 |

It will be understood that various details of the presently disclosed subject matter may be changed without departing from the scope of the presently disclosed subject matter. Furthermore, the foregoing description is for the purpose of illustration only, and not for the purpose of limitation.

1. A one-component (1K) cold bonding adhesive composition wherein the cold bonding adhesive composition comprises a chlorinated base polymer selected from the group consisting of a chlorinated elastomer and a chlorinated natural or synthetic rubber; a rubber curative agent selected from zinc oxide, magnesium oxide, or a mixture thereof; and an adhesion promoter; and wherein the 1K cold bonding adhesive is free of monomeric isocyanates and free of trichloroethylene.

2. The 1K cold bonding adhesive composition of claim 1, further comprising one or more additional chlorinated base polymer, wherein the one or more additional chlorinated base polymer is selected from the group consisting of a chlorinated elastomer, a chlorinated natural or synthetic rubber, and chlorinated polyol fines.

3. The 1K cold bonding adhesive composition of claim 1, wherein the adhesion promoter is selected from the group consisting of an epoxy functional silane, an amine functional silane, an acid functional silane, a ureido silane, a mercapto silane, a silane-terminated polymer, and hydroxyethylmethacrylate acid phosphate (HEMA phosphate).

4. (canceled)

5. The 1K cold bonding adhesive composition of claim 1, wherein the cold bonding adhesive further comprises a colorant, wherein the colorant is an organic or inorganic pigment.

6. (canceled)

7. The 1K cold bonding adhesive composition of claim 1, wherein the cold bonding adhesive further comprises a rheology modifier, wherein the rheology modifier is selected from a fumed silica powder, a treated clay, and mixtures thereof.

8. The 1K cold bonding adhesive composition of claim 1, wherein the cold bonding adhesive further comprises one or more water scavengers.

9. (canceled)

10. The 1K cold bonding adhesive composition of claim 1, wherein the 1K cold bonding adhesive, based on a total dry weight of the adhesive, comprises:
(a) about 60 weight % (wt %) to about 80 wt % of the chlorinated base polymer;
(b) about 10 wt % to about 20 wt % of one or more additional chlorinated base polymer;
(c) about 0.5 wt % to about 3 wt % of a colorant;
(d) about 4 wt % to about 10 wt % of a rheology modifier;
(e) about 3 wt % to about 6 wt % of the rubber curative agent;
(f) about 3 wt % to about 6 wt % of vinyltrimethoxysilane or PTSI;
(g) about 3 wt % to about 6 wt % of a zeolite powder or an organonanoclay; and
(h) about 2 wt % to about 6 wt % of the adhesion promoter.

11. The 1K cold bonding adhesive composition of claim 10, wherein the chlorinated base polymer is neoprene rubber, wherein the colorant is carbon black, wherein the rheology modifier is fumed silica powder, wherein rubber curative agent is zinc oxide, the vinyltrimethoxysilane or PTSI is vinyltrimethoxysilane; wherein the zeolite powder or organonanoclay is a zeolite powder; and wherein the adhesion promoter is an epoxy silane.

12. The 1K cold bonding adhesive composition of claim 1, further comprising one or more organic solvents.

13. (canceled)

14. A two-component (2K) cold bonding adhesive composition, wherein the cold bonding adhesive comprises a first component comprising a chlorinated base polymer selected from the group consisting of a chlorinated elastomer and a chlorinated natural or synthetic rubber; a rubber curative agent selected from zinc oxide, magnesium oxide, or a mixture thereof; and an adhesion promoter, and wherein the 2K cold bonding adhesive is free of trichloroethylene.

15. The 2K cold bonding adhesive composition of claim 14, wherein the chlorinated base polymer is neoprene latex.

16. The 2K cold bonding adhesive composition of claim 14, wherein the adhesion promoter is an epoxy silane.

17. The 2K cold bonding adhesive composition of claim 14, wherein the first component further comprises a colorant, wherein the colorant is an organic or inorganic pigment.

18. (canceled)

19. The 2K cold bonding adhesive composition of claim 14, wherein the first component further comprises one or more of a surfactant, a tackifier, a rheology modifier, and a defoamer.

20. The 2K cold bonding adhesive composition of claim 14, wherein the first component comprises an aqueous solvent.

21. The 2K cold bonding adhesive composition of claim 14, wherein the second component of the 2K cold bonding adhesive comprises a water-dispersible polyisocyanate.

22. A method of bonding a vulcanized elastomer substrate to a second substrate, wherein the second substrate comprises a second vulcanized elastomer substrate or a metal substrate, the method comprising:
(i) applying:
a one-component (1K) cold bonding adhesive composition wherein the cold bonding adhesive composition comprises a chlorinated base polymer selected from the group consisting of a chlorinated elastomer and a chlorinated natural or synthetic rubber: a rubber curative agent selected from zinc oxide, magnesium oxide, or a mixture thereof; and an adhesion promoter; and wherein the 1K cold bonding adhesive is free of monomeric isocyanates and free of trichloroethylene, or
applying a two-component (2K) cold bonding adhesive composition, wherein the cold bonding adhesive comprises a first component comprising a chlorinated base polymer selected from the group consisting of a chlorinated elastomer and a chlorinated natural or synthetic rubber; a rubber curative agent selected from zinc oxide, magnesium oxide, or a mixture thereof; and an adhesion promoter, and wherein the 2K cold bonding adhesive is free of trichloroethylene,
to a surface of one or both of the vulcanized elastomer substrate and the second substrate, thereby providing at least one adhesive-coated surface;
(ii) contacting the vulcanized rubber substrate to the second substrate wherein the at least one adhesive-coated surface is present between the vulcanized elastomer substrate and the second substrate; and
(iii) curing the adhesive.

23. The method of claim 22, wherein the at least one adhesive-coated surface is dried for a period of time prior to step (ii).

24. The method of claim 22, wherein the method further comprises applying a primer to a metal substrate.

25. The method of claim 22, wherein step (iii) is performed at an ambient temperature.

26. (canceled)

27. (canceled)
